(19) United States
(12) Patent Application Publication
(10) Pub. No.: US 2020/0325979 A1
(43) Pub. Date: Oct. 15, 2020

(54) SPRAY BAR FOR LUBRICATING GEAR MESHES IN AN EPICYCLIC TRANSMISSION

(71) Applicant: GE AVIO S.R.L., Rivalta di Torino (IT)

(72) Inventors: Michele Gravina, Rivalta di Torino (IT); Lorenzo Cipolla, Turin (IT); Federico Dellavalle, Pinerolo (IT)

(21) Appl. No.: 16/303,519

(22) PCT Filed: Jun. 2, 2017
(86) PCT No.: PCT/EP2017/063567

§ 371 Date: Nov. 20, 2018

(30) Foreign Application Priority Data
Jun. 7, 2016 (IT) 102016000058330

(51) Int. Cl. F16H 57/04; F16H 57/08

(52) U.S. Cl. CPC F16H 57/0479; F02C 7/36; F16H 57/082

(57) ABSTRACT

A spray bar for lubricating gear meshes in an epicyclic transmission has a base having an inlet designed to receive, in use, a flow of pressurized oil. The spray bar has two tube portions, which project from the base along respective axes, define respective channels parallel to each other and permanently communicating with the inlet, and are laterally defined by respective outer surfaces having outlet nozzles for spraying oil from the channels.

### BACKGROUND OF THE INVENTION

The present invention relates to a spray bar for lubricating gear meshes in an epicyclic transmission, in particular for a turbine engine. As a non-limiting embodiment, the following disclosure refers to a spray bar which defines part of an oil transfer unit that transfers oil from a stationary part to a rotating planet carrier of such epicyclic transmission.

As is known, an epicyclic transmission comprises a sun gear, a ring gear and a plurality of planet gears, which are located between the sun gear and the ring gear and are supported by a carrier. A transmission of such a type is capable of transmitting the motion between coaxial shafts rotating at different speeds and is very effective in providing such a function while maintaining small weight and volumes. Epicyclic transmissions are widely used in aeronautical turbine engines, to drive a fan (in so-called turbo-fan engines) or a propeller (in so-called turbo-propeller engines).

In most applications, the carrier is of static type and is coupled to a fixed frame of the engine by a flexible element.

On the other hand, certain applications employ a rotating carrier, by way of example when the carrier is connected to a rotating driven shaft or when there is a need to continuously control the speed ratio between the sun gear and the ring gear or, alternatively, between the carrier and the ring gear. In particular, the configuration of the epicyclic transmission is called “planetary” when the ring gear is stationary and the carrier is rotating, and “differential” when all three elements, i.e. sun gear, ring gear and carrier, are rotating.

In these cases, an oil transfer unit is generally provided to transfer the lubricant oil in an efficient and reliable manner from a static part to a rotating part connected to the carrier. Such oil transfer units are generally known as “oil transfer bearings” or as “rotary unions”. In particular, the unit supplies oil under pressure into an annular chamber defined by a sleeve which is fixed to the carrier. From such annular chamber, the pressurized oil flows towards the components requiring lubrication.

In particular, the gear meshes between the planet gears and the sun gear need to be lubricated and cooled by oil, i.e. the oil transferred by above-mentioned oil transfer unit. In this kind of solutions, U.S. Pat. No. 8,813,469 B2 discloses to provide a spray bar, which is mounted to the carrier in between each planetary gear, receives oil from the oil transfer unit and sprays such oil through nozzles on the sun gear.

A need is felt to improve the lubrication carried out by this kind of spray bar, so as to precisely aim the oil jets onto specific areas of the gears and to reduce, as much as possible, the risks of deviation or scattering of the oil jets.

Such deviation and scattering typically occurs because of windage, due to the rotation of the gears, and because of the rotation of the carrier (in the embodiments providing a rotating carrier, as in U.S. Pat. No. 8,813,469 B2), so that the oil does not precisely lubricate the areas established during the design stage.

Further needs are felt in this kind of solutions, such as: fixing the spray bars directly to the rotating part of the oil transfer unit, instead of providing a direct connection of the spray bars to the carrier, so as to design the carrier structure independently from the oil transfer needs; designing a lightweight spray bar; keeping the center of gravity of the spray bar as close as possible to the rotating part of the oil transfer unit, so as to obtain a satisfactory dynamic behavior for such rotating part; optimizing the angle of the oil jets angles at the design stage; and providing spray bars that are lightweight, compact and easy to be mounted.

It is the object of the present invention to provide a spray bar for lubricating gear meshes in an epicyclic transmission, which allows to meet the above-mentioned needs in a simple and cost-effective manner.

According to the present invention, a spray bar for lubricating gear meshes in an epicyclic transmission is provided, as defined in claim 1. The embodiments of the present invention are defined in dependent claims 2 to 12. Features of any of the claims may be readily combined with features of any of the other claims.

### BRIEF DESCRIPTION OF THE DRAWINGS

The present invention will now be described with reference to the accompanying drawings, which show a non-limiting embodiment thereof, in which:

FIG. 1 is an axial view of an embodiment of the spray bar for lubricating gear meshes in an epicyclic transmission, according to the present invention;

FIG. 2 is a cross section according to section plane II-II in FIG. 1 and shows the spray bar in an enlarged scale and without the components of the epicyclic transmission;

FIG. 3 is a cross section according to section plane in FIG. 2;

FIGS. 4 and 5 are different perspective views, in enlarged scales, of the spray bar according to the embodiment of the present invention; and

FIG. 6 is a cross section according to section plane II-II in FIG. 3.

### DETAILED DESCRIPTION

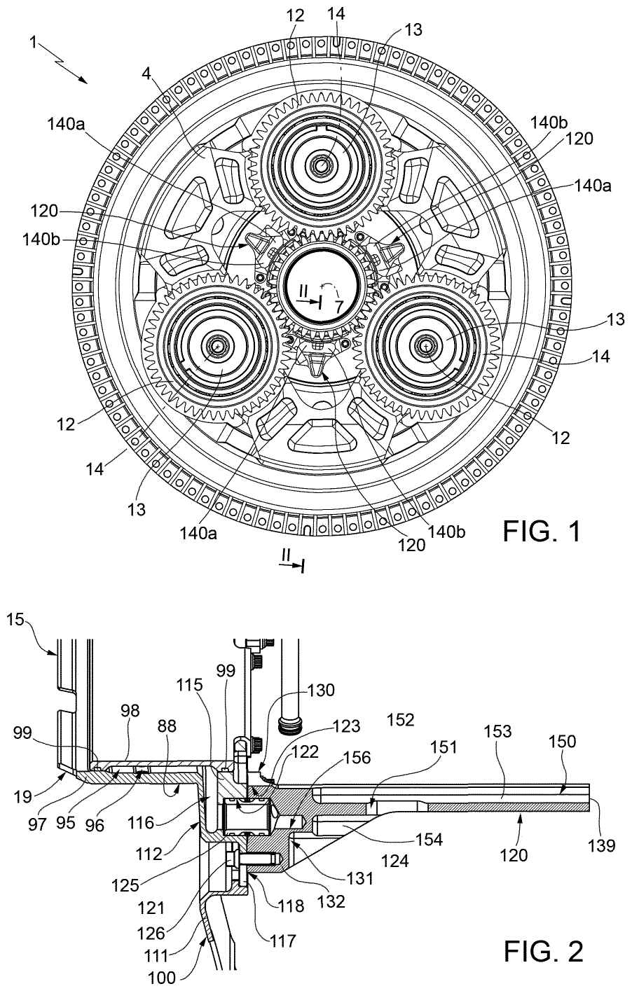

With reference to FIG. 1, reference numeral 1 indicates, as a whole, an epicyclic transmission (partially shown), in particular for a turbine engine (not shown). Transmission 1 comprises a planet carrier 4, rotating about an axis 7, and a sun gear (not shown), which is coaxial with the carrier 4, is also rotational about axis 7 and is connected to an input shaft (not shown) so as to be driven by a turbine.

Transmission 1 further comprises: a plurality of planet gears 12, which mesh with the sun gear, are supported by the carrier 4 by means of bearings 13 and are rotational about respective axes 14, parallel and eccentric with respect to axis 7; and a ring gear (not shown), coaxial with the sun gear and the carrier 4 and meshing with the planet gears 12 on the outer side.

In particular, the ring gear and the carrier 4 are connected in an angularly fixed manner to respective output members (not shown), which drive corresponding propellers.

With reference to FIG. 2, as the carrier 4 is rotatable, an oil transfer unit 15 (partially shown) is provided for transferring oil from a stationary part, fixed with respect to a supporting structure of the turbine engine, and to supply such oil towards the gear meshes of the transmission 1 and towards the planet bearings 13.

Unit 15 comprises a rotating part 19, coaxial and angularly fixed with respect to the carrier 4; and a non-rotating floating part (not shown) which is configured so as to transfer oil from the stationary part to part 19 and to have a certain degree of freedom in its movements with respect to part 18. The floating part is fitted onto an outer cylindrical surface 88 of part 19 with a radial gap in a non-contact configuration, i.e. without any additional contact sealing element and any contact bearing therebetween.

The size of such radial gap is defined during the design stage so as to allow for rotation of part 19 and, in the meantime, define a hydrostatic seal with an oil film along surface 88.

Part 19 has an inner annular chamber 95 and one or more radial holes 96, which permanently supply pressurized oil through surface 88 into chamber 95. Chamber 95, in turn, permanently communicates with a plurality of spray bars 120 to supply the pressurized oil towards such spray bars 120 and, therefore, lubricate the gear meshes and/or the planet bearings 13, as it will be described in detail further on.

In particular, chamber 95 is defined by an outer sleeve 97 and an inner sleeve 98, which are coaxial along axis 7 and are coupled to each other by means of sealing rings 99 to ensure fluid-tightness. By way of example, sleeves 97,98 are fixed to each other by screws.

Part 19 is coupled to the carrier 4 in an angularly fixed position by a disk member 100 (partially shown). Member 100 is coaxial with part 19 and carrier 4 and is fixed to sleeve 97, at one end, and to a front surface of carrier 4, at the opposite end. Member 100 is defined by a single piece, and not by pieces fixed to each other. As an alternative, it may be manufactured by welding separate pieces.

In particular, member 100 comprises a circular portion 111 coaxial to, and fitted around, a ring element 112 integral with the sleeve 97; and one or more flanges 113, which project from circular portion 111, rest onto element 112 and are fixed to the latter, by screws or bolts. Circular portion 111 has a plate-shaped cross-section, i.e. is defined by a wall having a relatively low thickness. In particular, the cross-section of the circular portion 111 is constant along the whole circumference. However, according to variants that are not shown, an appropriate thickness variation may be provided along such circumference.

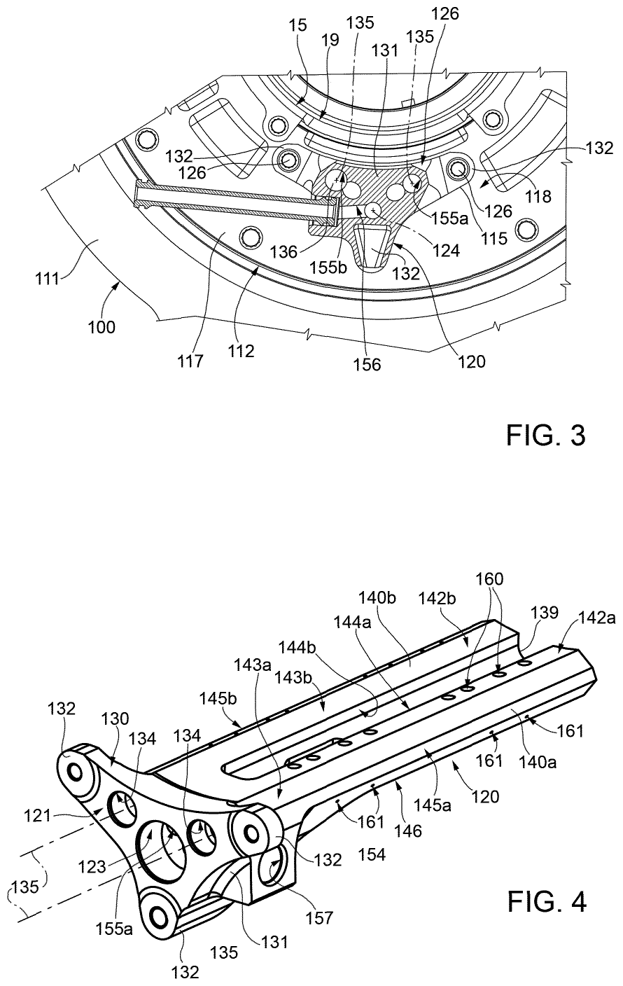

With reference to FIGS. 2 and 3, element 112 comprises an inner portion 115, defining a outwardly radial branch 116 of the chamber 95; and an outer flange 117, which radially projects from portion 115. Circular portion 111 is fitted onto flange 117 in coaxial position.

Element 112 defines a rear shoulder 118, which extends orthogonally to axis 7, and on which a front face 121 of each spray bar 120 axially rests.

Portion 115 has, for each spray bar 120, a respective outlet 122, which is defined by a hole parallel to axis 7 and permanently puts branch 116 into communication with an inlet 123 of the spray bar 120. In particular, inlet 123 is defined by a cylindrical opening made through face 121 along an axis 124 orthogonal to face 121. Inlet 123 and outlet 122 are coaxial and are both engaged by one tubular connector 125, commonly known as “jumper tube” and coupled to the inner surfaces of inlet 123 and outlet 122 in a fluid-tight manner, e.g. by sealing rings.

The following disclosure will refer to a single spray bar 120, for sake of simplicity, as the other ones have the same features.

Spray bar 120 is fixed to element 112, in particular by screws or bolts 126, engaging flange 117, and project from shoulder 118 along axis 124. As it can be seen in FIG. 1, spray bar 120 is arranged between two adjacent planet gears 12, along a circumferential direction, in a position radially facing and close to the sun gear, but spaced apart from the latter.

With reference to FIG. 4, spray bar 120 comprises a base 130, defined on one side by face 121 and comprising, in turn, an intermediate portion 131 and a plurality of lugs 132 projecting from portion 131 and engaged by respective screws 126 (FIGS. 2 and 3). Portion 131 has the above-mentioned inlet 123 and also two openings 134, which are made separately from inlet 123 along respective rectilinear axes 135, parallel to axis 124, and are closed in a fluid-tight manner by respective plugs 136 inserted into portion 131.

As shown in FIG. 6, openings 134 define the ends of respective channels 138a and 138b, which are parallel and are closed or blind at an axial end 139 of the spray bar 120, i.e. on the side axially opposite to openings 134. Spray bar 120 comprises two tube portions 140a and 140b, which project from base 130 along axes 135 and define, respectively, the main part of channels 138a and 138b (the other part being defined by portion 131 of base 130).

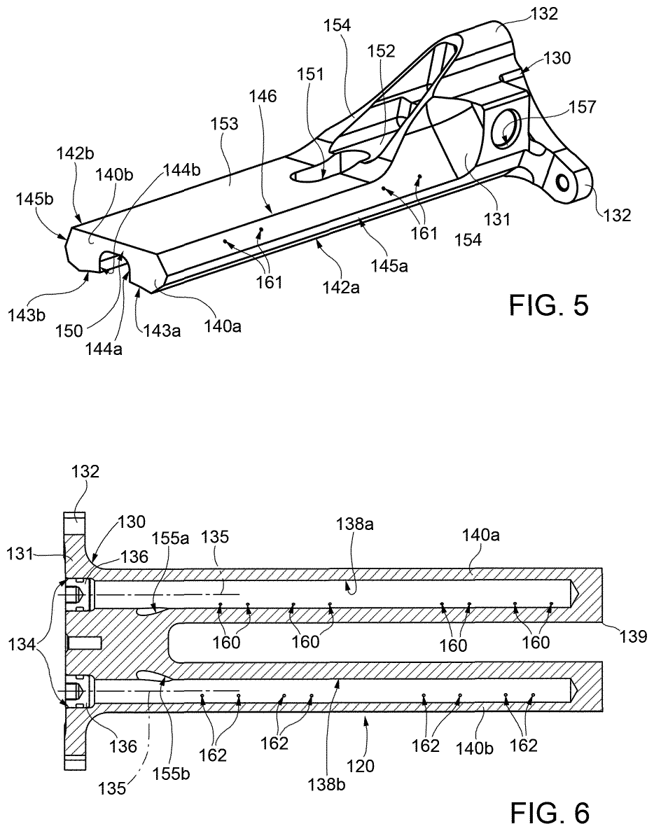

With reference to FIGS. 4 and 5, tube portions 140a, 140b are laterally defined by respective outer surfaces 142a, 142b extending parallel to axes 135. Surfaces 142a, 142b comprise respective faces 143a and 143b, which are arranged radially inwardly, with respect to axis 7, directly face the sun gear and are flush with each other at the portion 131. Surfaces 142a, 142b further comprise: respective faces 144a and 144b, facing each other along a circumferential direction; respective faces 145a and 145b, arranged on the side opposite to faces 144a and 144b (along the circumferential direction) and polygonal; and respective faces 146 arranged radially outwardly, with respect to axis 7.

Spray bar 120 further comprises a stiffening wall 150 (FIGS. 2 and 5), which joins the faces 144a and 144b to each other. Wall 150 has a through hole 151, which is radial, in relation to axis 7, and is arranged, in particular, in a position that is nearer to the base 130 than to the end 139.

In particular, hole 151 splits wall 150 in a thicker portion 152, projecting from portion 131, and in a less thick portion 153, at the end 139. In particular, portion 153 is flush with face 146. Spray bar 120 further comprises at least two stiffening ribs 154, that are transversal to face 146, are arranged on opposite sides of portion 152 and join face 146 to base 130.

Apart from the plugs 136, spray bar 120 is provided as a single piece, so that base 130, tube portions 140a and 140b, wall 150 and ribs 154 are integral with each other, without the need of assembly or welding operations for these components.

With reference to FIGS. 3 and 4, both channels 138a and 138b are supplied with oil from the same connector 125, i.e. from the same inlet 123. Indeed, the axial end of the inlet 123 defines a branch point, from which three separate conduits start. Two of such conduits are identified by reference numbers 155a and 155b, are at an angle with respect to axes 124 and 135 and put inlet 123 into communication with an intermediate portion of the channels 138a and 138b.

The third conduit is identified by reference number 156, has an L-shaped path, and puts inlet 123 into communication with a side outlet 157 of the base 130. A transfer tube 158 engages such outlet 157 in a fluid-tight manner and transfers oil towards a respective planet bearing 13 (in a manner that is not shown in detail).

As shown in FIGS. 4 to 6, tube portions 140a and 140b are provided with outlet nozzles, to spray respective oil jets from the channels 138a and 138b. The directions of such nozzles and oil jets are radial or tangential with respect to the axes 135.

Tube portion 140a has two rows of outlet nozzles 160 and 161, aimed towards the sun gear and towards one of the planet gears for cooling the gears teeth just after the completion of their meshing cycle, at an out-of-mesh position. In more detail, nozzles 160 are made through face 143a and are aimed to the sun gear, while nozzles 161 are made through face 145a and are aimed to the planet gear 12.

The exact orientation and diameter of the nozzles 160,161 are defined at the design stage to maximize the effectiveness of the oil jets.

On the other hand, tube portion 140b has a single row of outlet nozzles 162 (FIG. 6), aimed towards the meshing zone, for lubrication of the meshing teeth, at an into-mesh position. In particular, nozzles 162 are made through face 145b and aimed so as to spray oil at a position just before the meshing of the gears.

The exact orientation and diameter of the nozzles 162 are defined at the design stage to maximize the effectiveness of the oil jets.

On the one hand, the provision of at least two parallel and separate tube portions 140a,140b, instead of providing a single longitudinal channel, allows for arranging the nozzles 160,161,162 at a position that is closer to the target areas to be lubricated, than in the prior art.

Thanks to this closer position, the oil sprayed by the nozzles 160, 161 and 162 reaches the gears along a shorter path and, therefore, the oil jets are less scattered or deviated by the windage caused by the rotation of the gears and by the centrifugal field generated by the rotation of the planet carrier 4. Lubrication, therefore, corresponds to what has been set up during the design stage, as the oil precisely reaches the desired areas, without dispersion or waste of oil.

Besides, avoiding dispersion and waste of oil allows for avoiding or limiting the oversize of the oil flowrate during the design stage.

In the meantime, separate tube portions 140a,140b helps to minimize the size of the spray bar 120 and to obtain a design structure that is relatively easy to be manufactured.

Furthermore, the hole 151 allows, not only, for lightening the spray bar 120, but also for avoiding stagnation of oil that would tend to sediment between the tube portions 140a,140b.

As it is clear from the features that have been described above, the spray bars 120 have a particular structure, that is lightweight and stiff, and has a center of gravity arranged close to face 19, i.e. near part 19 that supports the spray bar 120 while rotating about axis 7, in order to obtain the best dynamic operating conditions.

In the meantime, the structure of the base 130 is relatively simple and allows for supplying oil to both channels 138a,138b, and also to the transfer tube 158, at the same time by means of a single inlet 123. It is evident that the base 130 is also relatively easy to be drilled, to manufacture all the passages necessary to supply and spray oil, as briefly mentioned above.

In addition, the assembly time are very low, as the only assembly operations consist in inserting the plugs 136 into the openings 134, so as to close the latter openings, and in mounting the spray bar 120 to the shoulder 118.

Furthermore, it is apparent from the above features and considerations that modifications or variants may be made to spray bar 120 without departing from the scope of protection, as defined by the appended claims.

In particular, the number and positions of the outlet nozzles (160-162) could be different from what disclosed for the embodiment; also the configuration of the passages provided to supply oil to the channels 138a, 138b could be different.

Moreover, the spray bars 120 can be mounted in epicyclic transmissions where the planet carrier is stationary, instead of being rotational.

What we claim is:

1. A spray bar for lubricating gear meshes in an epicyclic transmission, the spray bar comprising:
a base having at least one inlet designed
to receive, in use, a flow of pressurized oil;
a first tube portion, which projects from said base, defines a first channel permanently communicating with said inlet, and is laterally defined by a first outer surface having a plurality of outlet nozzles for spraying oil from said first channel;
characterized by comprising a second tube portion, which projects from said base, defines a second channel parallel to said first channel and is laterally defined by a second outer surface having a plurality of outlet nozzles for spraying oil from said second channel.

2. The spray bar according to claim 1, wherein said first and second channels are blind or closed at an end which is axially opposite to said base.

3. The spray bar according to claim 1, wherein said first and second channels both communicate with the same inlet.

4. The spray bar according to claim 1, wherein said base has two openings, which are separate from said inlet, are closed in a fluid-tight manner by respective plugs and define respective ends of said first and second channels.

5. The spray bar according to claim 1, wherein said base has: a side outlet for supplying oil to a transfer tube, and a conduit, that puts said inlet into communication with said side outlet.

6. The spray bar according to claim 1, wherein said first and second outer surfaces comprise respective faces facing each other; and by further comprising a stiffening wall, which joins said faces to each other.

7. The spray bar according to claim 6, wherein said stiffening wall, said first and second tube portions and said base define a single piece.

8. The spray bar according to claim 6, wherein said stiffening wall has a hole.

9. The spray bar according to claim 8, wherein said hole splits said wall in a thicker portion, projecting from said base, and in a less thick portion, arranged at an end which is axially opposite to said base.

10. The spray bar according to claim 1, comprising at least two stiffening ribs between said base and said first and second tube portions.

11. The spray bar according to claim 1, wherein said first tube portion has two rows of outlet nozzles.

12. The spray bar according to claim 1, wherein said second tube portion has a single row of outlet nozzles.
